(19) United States
(12) Patent Application Publication
(10) Pub. No.: US 2005/0108877 A1
(43) Pub. Date: May 26, 2005

(54) Apparatus and method for coupling a thermal dissipation device to an electronic substrate

(76) Inventor: Eric C. Peterson, McKinney, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/720,881

(22) Filed: Nov. 24, 2003

(51) Int. Cl. B23P 11/00; B21D 39/03

(52) U.S. Cl. 29/890.03; 29/428

(57) ABSTRACT

A system and method for coupling a thermal dissipation device to a substrate to be cooled and to an underlying support. The system includes a frame having an aperture, an upper surface abutting at least part of the bottom periphery of the thermal dissipation device, and a lower surface abutting the underlying support. A biasing element is positioned within the aperture of the frame and fastened to the thermal dissipation device. The biasing element urges the substrate into contact with the thermal dissipation device by applying a biasing force thereto, and decouples this biasing force from the force securing the heat sink to the underlying support.

### BACKGROUND

Electronic substrates, such as integrated circuit chips, chip carriers, and other components, are used with a wide variety of electronic devices to perform various computing and processing functions. Integrated circuits are usually pin-connected, soldered or otherwise connected to an underlying structure, such as a printed circuit board or card, to provide parallel functionality with other circuits and processors. In modern electronic devices, such as personal computers, as processor speeds are increased, integrated circuits require correspondingly more power and thus generate more heat. As a result, various thermal dissipation devices, including active and passive devices, have been developed to provide adequate heat dissipation.

Passive thermal dissipation devices, often termed ‘heat sinks’, are mounted on top of the substrate to be cooled. The substrate is typically inserted into a socket. In some systems, the socket is attached to an underlying support, such as a circuit board, via a ball grid array. The ball grid array includes a layer of solder balls for making electrical contact with the socket. Loads transmitted through components including the heat sink and substrate, and ultimately applied to the ball grid array by the socket, should be minimized to avoid long-term damage to the ball grid array.

It is necessary to clamp or otherwise press the heat sink against the substrate to maximize the heat transfer from the substrate. However, when clamping the heat sink and substrate to the circuit board, there is a limit to the clamping force applied to the heat sink that can be tolerated without adversely affecting the integrity of the ball grid array. A number of solutions have been proposed for mounting a heat sink onto the printed circuit card to provide a reliable thermal interface with an integrated circuit or other substrate. One such solution involves using fasteners to secure the heat sink to an underlying circuit card while clamping the integrated circuit tightly between both. However, as the clamping force is increased, progressive deformation of the ball grid array occurs, with the resulting damage to the array being a function of the clamping force. In addition, this mounting method can also cause the circuit card to warp due to bending stresses between the attachment location and the perimeter of the adjacent integrated circuit. Furthermore, the existing clamping force placed on the heat sink-substrate-socket-ball grid array assembly may be exacerbated during shipping and handling of the associated electronic device, when both static and dynamic loads are encountered.

### SUMMARY

A system is disclosed for coupling a thermal dissipation device to a substrate to be cooled and to an underlying support. The system includes a frame having an aperture, an upper surface abutting at least part of the bottom periphery of the thermal dissipation device, and a lower surface abutting the underlying support. A biasing element is positioned within the aperture of the frame and fastened to the thermal dissipation device. The biasing element urges the substrate into contact with the thermal dissipation device by applying a biasing force thereto, and decouples this biasing force from the force securing the heat sink to the underlying support.

A method is also disclosed for coupling a heat sink to a substrate to be cooled and to a circuit board. The method includes the steps of placing the substrate against the heat sink; placing a biasing element against the substrate; fastening the biasing element to the heat sink so that the biasing element urges the substrate against the heat sink; attaching a frame to the heat sink to form a unit; and mounting the unit to the circuit board such that the substrate is in electrical contact with a socket affixed to the circuit board.

### BRIEF DESCRIPTION OF THE DRAWINGS

FIG. 1 is a top perspective view showing an exemplary system for coupling a thermal dissipation device to an electronic substrate mounted on a circuit board;

FIGS. 2 and 3 are cross-sectional views taken along lines 2-2 and 3-3 in FIG. 1, respectively, showing exemplary components of the present system; and

FIG. 4 is an exploded perspective view showing exemplary individual components of the system shown in FIGS. 1-3.

### DETAILED DESCRIPTION

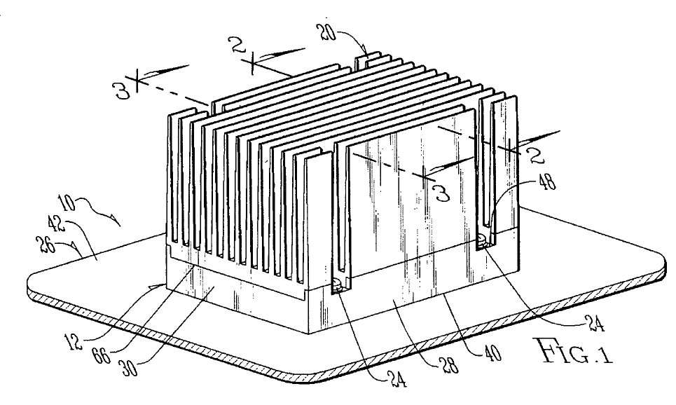

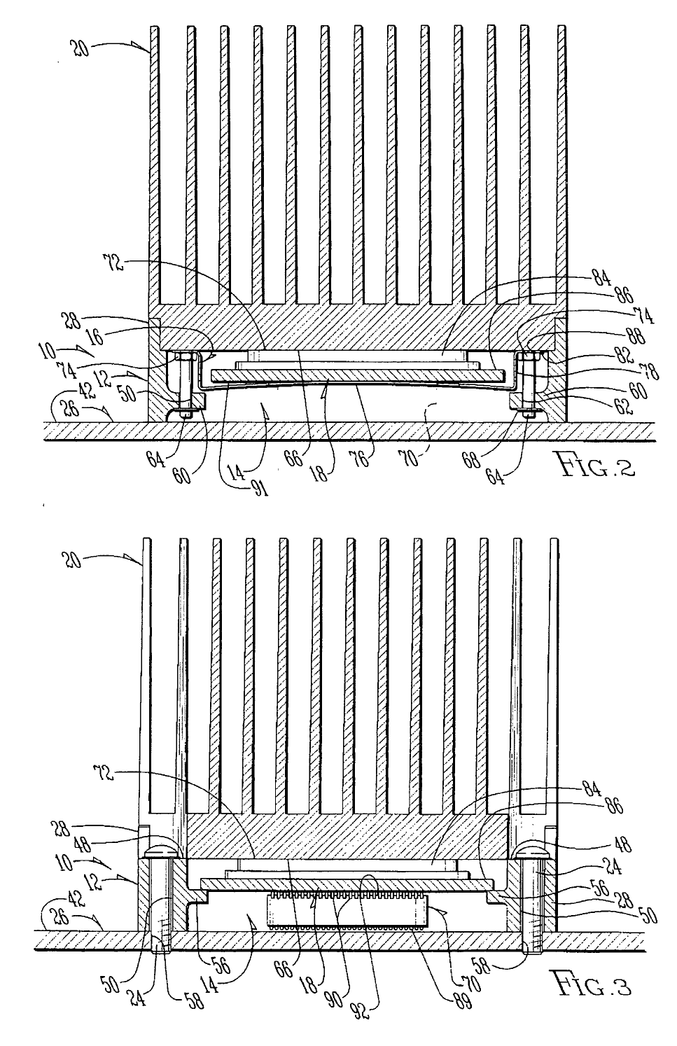

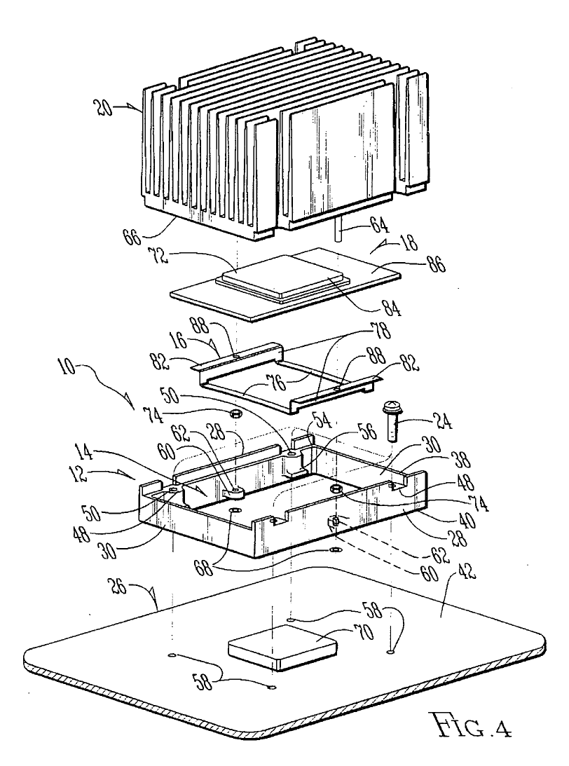

FIGS. 1-4 show an exemplary system 10 for coupling a thermal dissipation device 20 to an electronic substrate 18, and for mounting the thermal dissipation device and substrate to an underlying support, such as a daughter card or other circuit board 26. FIG. 1 is a top perspective view, and FIGS. 2 and 3 are cross-sectional views taken along lines 2-2 and 3-3 of FIG. 1, respectively, showing exemplary components of the present system 10. FIG. 4 is an exploded perspective view showing exemplary components of the system shown in FIGS. 1-3.

As best seen from FIGS. 2 and 4, system 10 comprises a biasing element 16 and a frame 12. System 10 functions with thermal dissipation device 20, electronic substrate 18, socket 70, and circuit board 26. Substrate 18 includes a device 84 having a support plate 86. Device 84 is typically an integrated circuit, but may be any type of electronic device, and may or may not include a support plate 86. As shown in FIG. 1, thermal dissipation device 20, hereinafter ‘heat sink’ 20, is mounted directly onto frame 12, which is rigidly attached to circuit board 26. As shown in FIG. 3, pin array 90 on substrate 18 interfaces with socket 70, which may be attached to circuit board 26 via an optional ball grid array 89.

As shown in FIG. 4, frame 12, heat sink 20, and biasing element 16 are registered with respect to one another by aligning bores 62 in tabs 60 on frame 12 with holes 88 in biasing element 16 to accommodate pins 64 attached to heat sink 20. In an exemplary embodiment, frame 12 is secured to heat sink 20 by locking clips 68, such as Tinnerman clips, which are pushed onto heat sink pins 64 until the clips 68 make contact with tabs 60 on frame 12 and tabs 56 make contact with surface 91 (FIG. 3) on substrate 18. As described in detail below, biasing element 16 is attached to heat sink 20 and heat sink 20 is attached to frame 12 independently of the attachment of the heat sink and frame to circuit board 26 to separate the force needed to press substrate 18 against heat sink 20 from the force generated in clamping the heat sink and frame to the circuit board 26.

Frame 12 is a generally rectangular structure with a first and second pair of frame members 28, 30 defining aperture 14. The top edge 38 of frame 12 is configured to receive at least part of the bottom periphery of heat sink 20. The bottom edge 40 of frame 12 is configured to rest on circuit board top surface 42. In an exemplary embodiment, frame 12 is attached to circuit board 26 by mounting pins 24, which fit through bores 50 in receiving members 48 in frame 12 and through bores 58 in circuit board 26. Mounting pins 24 may be any type of fastener, such as a pin or bolt that is pinned or threaded into the circuit board 26 or into a plate (not shown) on the bottom side of the circuit board 26. Each bore 50 may also be threaded and the mounting pins 24 inserted from the far side of circuit board 26 as well. Frame 12 includes lateral lips or tabs 56 extending from receiving members 48 that locate frame 12 to surface 91 on substrate 18 with minimal force.

Alternatively, tabs 56 may used to provide the force against substrate 18 necessary for the thermal interface between surface 72 on device 84 and surface 66 of heat sink 12. In an exemplary embodiment, frame 12 is made from moldable material, such as a hard plastic, such that members 28, 30, receiving members 48, and tabs 60 all form a unitary body. Frame 12 may be fabricated from other, preferably non-conductive, material.

The thickness of substrate 18 and the height of frame 12 (i.e., the distance between the top edges 38 of frame members 30 and the top of circuit board 26) determine the distance, or separation, between the bottom surface of substrate 18 and the top surface 42 of socket 70 when substrate pin array 90 is inserted into the socket 70. This substrate-to-socket distance is established for an integrated circuit chip having a particular thickness, and is modified, by changing the height of frame 12, to accommodate various other chips as a function of their thickness. In an exemplary embodiment, there is a slight separation between the between the bottom surface of substrate 18 and the top surface 42 of socket 70, to further isolate socket 70 and underlying ball grid array 89 from heat sink 20. The separation between substrate lower surface 91 and socket top surface 92 eliminates any load from being transferred to socket 70 and ball grid array 89 by forces applied to heat sink 20 when the heat sink is attached to circuit board 26.

Biasing element 16 includes two biasing members 76 which provide a compressive, or biasing force, to urge substrate 18 against heat sink 20, so that the upper surface 72 of the substratescontacts the bottom surface 66 of heat sink 20. In an exemplary embodiment, biasing members 76 are arched metal strips that function as leaf springs. Each of the biasing members 76 thus forms an arc, a substantial portion of which deforms when pressed against the lower surface 91 of the substrate 18 to urge substrate top surface 72 into contact with heat sink bottom surface 66. Biasing members 76 may, alternatively, comprise any other type of mechanism for urging substrate 18 into contact with heat sink 20; for example, biasing members 76 could be used to compress small coil springs or belleville washers between biasing members 76 and surface 91 of substrate 18. Optionally, to increase thermal energy transfer, a thermal interface material (not shown), such as thermal grease or other heat-conductive medium, may be applied to the substrate top surface 72 and/or heat sink bottom surface 66. The thermal interface material is applied in a layer of suitable thickness, for example, about 0.05 to 0.25 millimeters thick.

In an alternative embodiment, biasing element 16 may be used to hold the substrate 18 in position until frame 12 is fastened to heat sink 20 with a predetermined load. This may be accomplished by applying a predetermined load to frame 12 and then installing clips 68 onto posts 64 until the clips 68 make contact with tabs 60.

As shown in FIG. 4, biasing members 76 are connected to support members 78 at opposite ends thereof to form a rectangular unit 16 with an aperture through which pin array 90 of substrate 18 passes when the substrate is inserted into socket 70. In an exemplary embodiment, support members 78 include flanges 82 extending outwardly from the top of members 78, forming an ‘L’-shaped cross-section. Holes 88 in flanges 82 are aligned with bores 62 in frame tabs 60 to accommodate heat sink pins 64, which register biasing element 16, heat sink 20 and frame 12 with respect to each other. In an exemplary embodiment, biasing element 16 is fabricated from metal, such as stainless steel, beryllium copper or phosphor bronze, but may, alternatively, be formed from a material such as fiberglass or fiber-reinforced plastic.

In an exemplary embodiment, biasing element 16 is attached to heat sink 20 via nuts 74 that are fastened to pins 64 via threads located near the upper end thereof and extending below heat sink lower surface 66. In an alternative embodiment, biasing element 16 is attached to heat sink 20 by other mounting means, such as four screws (not shown), each of which disposed through a respective bore in one of the flanges 82 on biasing element support members 78, and fastened to heat sink 20 via a tapped bore therein.

The forces exerted by biasing members 76 against the bottom surface 91 of substrate 18 maintian good uniform contact between substrate top surface 72 and heat sink surface 66, thus maximizing heat transfer from substrate 18 to heat sink 20. In the present configuration, biasing element 16 effectively physically isolates substrate 18, underlying socket 70, and ball grid array 89 from loads applied between substrate 18 and heat sink 20. Therefore, static and dynamic loads placed on heat sink 20 are transferred through frame 12 to circuit board 26, and are not substantially borne by substrate 18, nor transferred to socket 70 or ball grid array 89.

From the forgoing description, it should be apparent that the present system 10 provides a heat transfer mechanism to prevent an electronic substrate from overheating, while isolating, from the substrate loads applied to the heat sink. Certain changes may be made in the above methods and systems without departing from the scope of the present system. It is to be noted that all matter contained in the above description or shown in the accompanying drawings is to be interpreted as illustrative and not in a limiting sense.

1. A system for coupling a thermal dissipation device to a substrate to be cooled and to an underlying support, the system comprising:
a frame having an aperture therewithin, an upper surface configured to abut at least part of the bottom periphery of the thermal dissipation device, and a lower surface configured to abut the underlying support; and
a biasing element, configured to be fastened to the thermal dissipation device and disposed within the aperture of the frame, for urging the substrate into contact with the thermal dissipation device.

2. The system of claim 1, wherein the biasing element comprises two parallel arched leaf springs and two parallel support members connected at opposite ends of the springs to form a rectangular unit.

3. The system of claim 2, wherein each of the leaf springs forms an arc, a substantial portion of which deforms to contact a lower surface of the substrate when the biasing element is fastened to the thermal dissipation device.

4. The system of claim 2, wherein each of the support members include an aperture configured to be aligned with bores in the frame to receive pins extending from the heat sink.

5. The system of claim 2, including mounting means for fastening the biasing element to the thermal dissipation device comprising at least two pins extending from the thermal dissipation device through respective bores in the support members of the biasing element.

6. The system of claim 5, wherein the pins are threaded proximate at least one end thereof, and the biasing element is fastened to the thermal dissipation device via nuts placed over each of the pins.

7. The system of claim 5, including tabs disposed on opposite inside edges of the frame, wherein the thermal dissipation device is fastened to the frame via a set of locking clips placed over the pins to abut the tabs.

8. The system of claim 1, wherein the biasing element applies to the substrate a biasing force that is decoupled from the force securing the heat sink to the underlying support.

9. The system of claim 1, including fastening means for fastening the thermal dissipation device and the frame to the underlying support, comprising a plurality of pins extending through bores in the thermal dissipation device, sidewalls of the frame, and the underlying support.

10. The system of claim 1, wherein the biasing element is configured to be fastened to the frame.

11. A system for coupling a heat sink to a substrate to be cooled and to a circuit board, the system comprising:
a frame having an aperture therewithin, an upper surface configured to abut at least part of the bottom periphery of the heat sink, and a lower surface configured to abut the circuit board, wherein a pin array on the substrate is disposed through the aperture to make electrical contact with a socket attached to an upper surface of the circuit board;
a biasing element, disposed within the aperture of the frame and generating a biasing force to urge the substrate into contact with the heat sink;
fastening means generating a clamping force coupling the frame between the heat sink and the circuit board; and
mounting means securing the biasing element to the heat sink such that said biasing force is substantially decoupled from said clamping force.

12. The system of claim 11, wherein the biasing element is secured to the frame.

13. The system of claim 11, wherein the fastening means comprises a plurality of threaded pins extending through bores in the heat sink, sidewalls of the frame, and the circuit board, wherein nuts are placed over threads on the pins abutting a lower surface of the circuit board.

14. The system of claim 11, wherein the distance between the top edges of the frame and the upper surface of the circuit board is established to maintain a separation between a bottom surface of the substrate and a top surface of the socket.

15. The system of claim 11, including tabs disposed on opposite inside edges of the frame, wherein the heat sink is fastened to the frame via a set of locking clips placed over the pins to abut the tabs.

16. The system of claim 11, wherein the biasing element comprises two parallel leaf springs and two parallel support members, wherein each end of each of the springs is connected to a respective end of one of the support members to form a rectangular unit.

17. The system of claim 16, wherein each of the leaf springs forms an arc, a substantial portion of which deforms to contact a lower surface of the substrate when the biasing element is fastened to the heat sink.

18. The system of claim 16, wherein the mounting means comprises at least two pins extending from the heat sink through respective bores in the support members of the biasing element, wherein the pins are threaded proximate at least one end thereof, and the biasing element is fastened to the heat sink via nuts placed over each of the pins.

19. A method for coupling a heat sink to a substrate to be cooled and to a circuit board comprising the steps of:
placing a first surface of the substrate against a surface of the heat sink;
placing a biasing element against a second surface of the substrate;
fastening the biasing element to the heat sink so that the biasing element urges the first surface of the substrate against the surface of the heat sink;
attaching a frame to the heat sink to form a unit, wherein the frame includes an aperture containing the biasing element; and
mounting the unit to the circuit board such that the substrate is in electrical contact with a socket affixed to the circuit board.

20. The method of claim 19, wherein a separation is maintained between the top surface of the socket and the bottom surface of the substrate.

21. The method of claim 19, wherein the step of attaching the frame to the heat sink comprises:
sliding a set or bored tabs, disposed on opposite inside edges of the frame, over a set of pins extending from the heat sink; and
fastening the heat sink to the frame via a set of locking clips placed over the pins to abut the tabs.

22. The method of claim 19, wherein the biasing element comprises two parallel leaf springs and two parallel support members, wherein each end of each of the springs is connected to a respective end of one of the support members to form a rectangular unit.

23. The method of claim 22, wherein each of the leaf springs forms an arc, a substantial portion of which deforms to contact a lower surface of the substrate when the biasing element is fastened to the heat sink.

24. The method of claim 22, wherein at least two pins extend from the heat sink through respective bores in the support members of the biasing element, wherein the pins are threaded proximate at least one end thereof, and the biasing element is fastened to the heat sink via nuts placed over each of the pins.

25. A system for coupling a heat sink to a substrate to be cooled and to a circuit board having a socket attached thereto, the system comprising:
biasing means, attached to the heat sink, for urging the substrate into contact with the heat sink; and
frame means, containing the biasing means, for attaching the heat sink to the circuit board such that the substrate is in electrical contact with a socket affixed to the circuit board, and a separation is maintained between a top surface of the socket and a bottom surface of the substrate.

26. The system of claim 25, wherein the biasing means comprises two parallel arched leaf springs and two parallel support members connected at opposite ends of the springs to form a rectangular unit.

27. The system of claim 26, wherein each of the leaf springs forms an arc, a substantial portion of which deforms to contact a lower surface of the substrate when the biasing element is fastened to the heat sink.

28. The system of claim 26, wherein the system includes at least two pins extending from the heat sink through respective bores in the support members of the biasing means, wherein the pins are threaded proximate at least one end thereof, and the biasing means is fastened to the heat sink via nuts placed over each of the pins.
